(19) United States
(12) Patent Application Publication
(10) Pub. No.: US 2011/0001705 A1
(43) Pub. Date: Jan. 6, 2011

(54) REMOTE CONTROL SYSTEM AND METHOD

(75) Inventor: TENG-YU TSAI, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/579,253

(22) Filed: Oct. 14, 2009

(30) Foreign Application Priority Data
Jul. 6, 2009 (CN) 200910304050.8

(51) Int. Cl. G06F 3/02

(52) U.S. Cl. 345/168

(57) ABSTRACT

A remote control method comprising an input terminal connecting to a remote embedded electronic device. The embedded electronic device receives a command with a combination key code by pressing a direction key. The embedded electronic device analyzes the command with the combination key code and executes corresponding action according to the combination key code.

### BACKGROUND

1. Technical Field

The present disclosure relates to a remote control system in an embedded electronic device and method.

2. Description of Related Art

Embedded devices, for example, digital photo frames (DPFs) are becoming increasingly popular due to their convenience and ease of manipulation when implementing particular functions. Recently, many embedded devices can only be controlled by an infrared (IR) controller, which is a problem if the controller is lost.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a schematic view of a remote control system.

FIG. 2 is a flowchart of a remote control method.

FIG. 3 is a schematic view of the input terminal controlling the embedded electronic device.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage device.

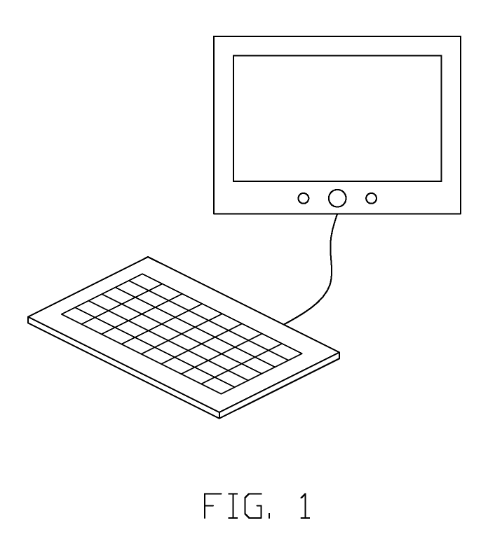

Referring to FIG. 1, a remote control system includes an input terminal and an embedded electronic device operated by the input terminal. The input terminal has a keyboard. The input terminal can connect to the embedded electronic device through a serial port based on teletype network (Telnet) protocol. The embedded electronic device may be a digital photo frame (DPF), or other multimedia electronic device.

The keyboard includes many keys. When any key is pressed, the input terminal sends a command to a first-in first-out (FIFO) pipe of the embedded electronic device. The command is handled in a first-in first-out manner in the embedded electronic device. The embedded electronic device includes a key code analyzer module to analyze the command with a key code or a combination key code. If a direction key is pressed, the combination key code will be sent to the embedded electronic device. The embedded electronic device executes a corresponding action according to the key code or the combination key code. The key code or the combination key code is an American Standard Code for Information Interchange (ASCII) code, for example a key code “97” would mean the lower case letter “a”.

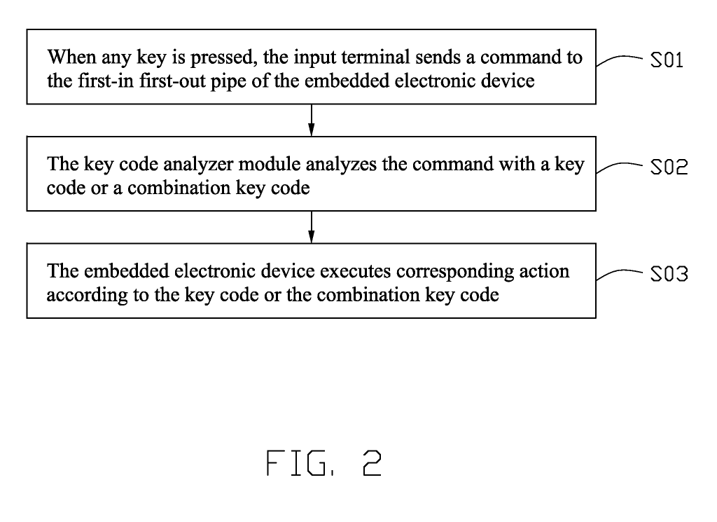

FIG. 2 is a flowchart illustrating one embodiment of a remote control method in an embedded electronic device. According to the embodiment, additional blocks in the flow of FIG. 2 may be added, others removed, and the ordering of the blocks may be changed.

In block S01, when any key is pressed, the input terminal sends a command to the first-in first-out pipe of the embedded electronic device.

In block S02, the key code analyzer module analyzes the command with a key code or a combination key code.

In block S03, the embedded electronic device executes corresponding action according to the key code or the combination key code.

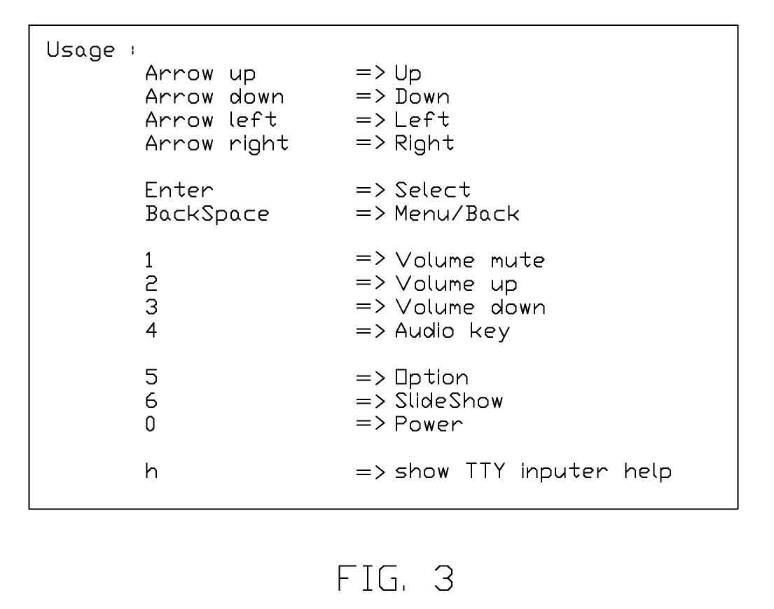

FIG. 3 is a schematic view of the input terminal controlling the embedded electronic device with examples of keys and their uses. “Arrow up” on the input terminal indicates a command to move an on-screen indicator “up”. “Enter” on the input terminal indicates “select”. “Backspace” on the input terminal indicates “menu/back”. “1” on the input terminal indicates “volume mute”. “6” on the input terminal indicates “slideshow”. “0” on the input terminal indicates “power”.

It is to be understood, however, that even though numerous characteristics and advantages of the disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

It is also to be understood that the above description and the claims drawn to a method may include some indication in reference to certain steps. However, the indication used is only to be viewed for identification purposes and not as a suggestion as to an order for the steps.

What is claimed is:

1. A remote control system, comprising:
an input terminal comprising a direction key, the direction key defining a combination key code, the combination key code comprising at least two key values;
an embedded electronic device controlled by the input terminal, the embedded electronic device comprising a key code analyzer module;
wherein the input terminal is capable of sending the combination key code to the embedded electronic device by pressing the direction key, the key code analyzer module is capable of parsing the combination key code to do a selecting action on a user interface of the embedded electronic device.

2. The remote control system of claim 1, wherein the input terminal is a keyboard.

3. The remote control system of claim 1, wherein the input terminal further includes a plurality of letter keys, each letter key defines one key value.

4. The remote control system of claim 3, wherein the key value is American Standard Code for Information Interchange (ASCII) code value.

5. The remote control system of claim 3, wherein the key code analyzer module is capable of parsing the one key value for each letter key to start up a menu.

6. The remote control system of claim 3, wherein the key code analyzer module is capable of parsing the one key value for each letter key to power on or shut down the embedded electronic device.

7. The remote control system of claim 3, wherein the key code analyzer module is capable of parsing the one key value for each letter key to instruct a volume to mute, down or up.

8. The remote control system of claim 1, wherein the input terminal is capable of sending the combination key code to the embedded electronic device through a serial port.

9. The remote control system of claim 1, wherein the input terminal is capable of sending the combination key code to the embedded electronic device through a teletype network (Telnet) protocol.

10. The remote control system of claim 1, wherein the input terminal is capable of sending the combination key code to a first-in first-out pipe of the embedded electronic device to execute the combination key code by the first-in first-out manner.

11. A remote control method, comprising:
an input terminal connecting to a remote embedded electronic device;
the embedded electronic device receiving a command with a combination key code by pressing a direction key; and
the embedded electronic device analyzing the command with the combination key code and executing corresponding action according to the combination key code.

12. The remote control method of claim 11, wherein the input terminal is a keyboard.

13. The remote control method of claim 12, wherein the input terminal further includes a letter key defining one key value.

14. The remote control method of claim 13, wherein the key value is American Standard Code for Information Interchange (ASCII) code value.

15. The remote control method of claim 13, wherein the key code analyzer module parses the one key value for each letter key to start up a menu.

16. The remote control method of claim 13, wherein the key code analyzer module parses the one key value for each letter key to power on or shut down the embedded electronic device.

17. The remote control method of claim 13, wherein the key code analyzer module parses the one key value for each letter key to instruct a volume to mute, down or up.

18. The remote control method of claim 11, wherein the input terminal sends the combination key code to the embedded electronic device through a serial port.

19. The remote control method of claim 11, wherein the input terminal sends the combination key code to the embedded electronic device through a teletype network (Telnet) protocol.

20. The remote control method of claim 11, wherein the input terminal sends the combination key code to a first-in first-out pipe of the embedded electronic device to execute the combination key code by the first-in first-out manner.
